(19) United States
(12) Patent Application Publication
(10) Pub. No.: US 2009/0287928 A1
(43) Pub. Date: Nov. 19, 2009

(54) Methods, Portable Electronic Devices, Systems and Computer Program Products for Securing Electronic Conference Room Whiteboards

(75) Inventor: Andrew Jonathan Braun, Cary, NC (US)

Correspondence Address: MYERS BIGEL SIBLEY & SAJOVEC, P.A., P.O. BOX 37428, RALEIGH, NC, 27627, US

(73) Assignee: Sony Ericsson Mobile Communications AB

(21) Appl. No.: 12/120,991

(22) Filed: May 15, 2008

(51) Int. Cl. H04L 9/32

(52) U.S. Cl. 713/171; 726/7; 713/186

(57) ABSTRACT

Methods, portable electronic devices, systems and computer program products for securing an electronic whiteboard. A near field communication (NFC) session is established between a portable electronic device and the electronic whiteboard to secure information provided on the electronic whiteboard. Dispersion of the information provided on the electronic whiteboard is enabled and/or disabled using security credentials associated with the established NFC session.

### FIELD OF THE INVENTION

The present invention relates to secure transactions, and, more particularly, to methods, systems, and computer program products for performing transactions using Near Field Communication (NFC) technology.

### BACKGROUND OF THE INVENTION

Conference rooms are typically equipped with whiteboards that allow meeting participants to illustrate their thoughts and ideas. Recently, modern conference rooms have been equipped with electronic whiteboards that look just like regular whiteboards, but provide users the capability to print out the contents of the whiteboard. Some electronic whiteboards may be configured to be connected to a computer, such that the contents of the whiteboard can be downloaded to the computer and printed, saved, changed, faxed and/or emailed. The capability of retrieving the contents of the whiteboard may allow for dynamic team collaboration where the whole team can participate in, for example, a brainstorming session or meeting without making sure everything on the board is captured by writing down, typing it into the computer or the like. Whenever meeting participants want to capture the contents of the whiteboard, for example, when the whiteboard is full or the meeting is over, a simple button press copies the contents of the board onto paper or downloads the contents of the whiteboard to a computer.

### SUMMARY OF THE INVENTION

Some embodiments of the present invention provide methods, portable electronic devices, systems and computer program products for securing information on an electronic whiteboard. A near field communication (NFC) session is established between a portable electronic device and the electronic whiteboard to secure information provided on the electronic whiteboard. Dispersion of the information provided on the electronic whiteboard is enabled and/or disabled using security credentials associated with the established NFC session.

In further embodiments of the present invention, the security credentials may include a unique key associated with an identifier that identifies a user of the portable electronic device. The unique key may be transmitted to the electronic whiteboard and a unique sharing code may be received from the electronic whiteboard responsive to the transmission of the unique key.

In still further embodiments of the present invention, the sharing code received from the electronic whiteboard may be transmitted to at least one other portable electronic device so as to allow others access to the information provided on the electronic whiteboard. In certain embodiments, limited access to the information provided on the electronic whiteboard may be provided to the at least one other portable electronic device receiving the sharing code.

In some embodiments of the present invention, information on the electronic whiteboard may be automatically erased from a previous session.

In further embodiments of the present invention, the information provided on the electronic whiteboard may be stored or printed.

In still further embodiments of the present invention, the information provided on the electronic whiteboard may be automatically stored at the electronic whiteboard and at the portable electronic device using the established NFC session.

In some embodiments of the present invention, verification of a biometric link may be required to access the security credentials associated with the NFC session.

Further embodiments of the present invention provide methods, portable electronic devices, systems and computer program products for securing an electronic whiteboard. A request for a near field communication (NFC) session between a portable electronic device and the electronic whiteboard to secure information provided on the electronic whiteboard is received. Security credentials associated with the established NFC connection is also received. The security credentials include a unique key associated with an identifier that identifies a user of the portable electronic device. A unique sharing code is provided from the electronic whiteboard to the portable electronic device responsive to the provision of the unique key.

In still further embodiments of the present invention, a request for dispersion of the information provided on the electronic whiteboard may be received. The request may include the security credentials associated with the established NFC session. The security credentials may be verified. The requested dispersion may be provided if the security credentials are verified.

### BRIEF DESCRIPTION OF THE DRAWINGS

FIG. 1 is a schematic block diagram illustrating a network including portable electronic devices and an electronic whiteboard in accordance with some embodiments of the present invention.

FIG. 2 is a schematic block diagram illustrating a portable electronic device and a cellular communication system in accordance with some embodiments of the present invention.

FIGS. 3 through 6 are flowcharts illustrating methods according to various embodiments of the present invention.

### DETAILED DESCRIPTION OF EMBODIMENTS OF THE INVENTION

The present invention will be described more fully hereinafter with reference to the accompanying figures, in which embodiments of the invention are shown. This invention may, however, be embodied in many alternate forms and should not be construed as limited to the embodiments set forth herein.

Accordingly, while the invention is susceptible to various modifications and alternative forms, specific embodiments thereof are shown by way of example in the drawings and will herein be described in detail. It should be understood, however, that there is no intent to limit the invention to the particular forms disclosed, but on the contrary, the invention is to cover all modifications, equivalents, and alternatives falling within the spirit and scope of the invention as defined by the claims. Like numbers refer to like elements throughout the description of the figures.

The terminology used herein is for the purpose of describing particular embodiments only and is not intended to be limiting of the invention. As used herein, the singular forms “a”, “an” and “the” are intended to include the plural forms as well, unless the context clearly indicates otherwise. It will be further understood that the terms “comprises”, “comprising,” “includes” and/or “including” when used in this specification, specify the presence of stated features, integers, steps, operations, elements, and/or components, but do not preclude the presence or addition of one or more other features, integers, steps, operations, elements, components, and/or groups thereof. Moreover, when an element is referred to as being “responsive” or “connected” to another element, it can be directly responsive or connected to the other element, or intervening elements may be present. In contrast, when an element is referred to as being “directly responsive” or “directly connected” to another element, there are no intervening elements present. As used herein the term “and/or” includes any and all combinations of one or more of the associated listed items and may be abbreviated as “/”.

Unless otherwise defined, all terms (including technical and scientific terms) used herein have the same meaning as commonly understood by one of ordinary skill in the art to which this invention belongs. It will be further understood that terms used herein should be interpreted as having a meaning that is consistent with their meaning in the context of this specification and the relevant art and will not be interpreted in an idealized or overly formal sense unless expressly so defined herein.

It will be understood that, although the terms first, second, etc. may be used herein to describe various elements, these elements should not be limited by these terms. These terms are only used to distinguish one element from another. For example, a first element could be termed a second element, and, similarly, a second element could be termed a first element without departing from the teachings of the disclosure. Although some of the diagrams include arrows on communication paths to show a primary direction of communication, it is to be understood that communication may occur in the opposite direction to the depicted arrows.

Example embodiments are described below with reference to block diagrams and/or flowchart illustrations of methods, devices, systems and/or computer program products. It is understood that a block of the block diagrams and/or flowchart illustrations, and combinations of blocks in the block diagrams and/or flowchart illustrations, can be implemented by computer program instructions. These computer program instructions may be provided to a processor of a general purpose computer, special purpose computer, and/or other programmable data processing apparatus to produce a machine, such that the instructions, which execute via the processor of the computer and/or other programmable data processing apparatus, create means (functionality) and/or structure for implementing the functions/acts specified in the block diagrams and/or flowchart block or blocks.

These computer program instructions may also be stored in a computer-readable memory that can direct a computer or other programmable data processing apparatus to function in a particular manner, such that the instructions stored in the computer-readable memory produce an article of manufacture including instructions which implement the functions/acts specified in the block diagrams and/or flowchart block or blocks.

The computer program instructions may also be loaded onto a computer or other programmable data processing apparatus to cause a series of operational steps to be performed on the computer or other programmable apparatus to produce a computer-implemented process such that the instructions which execute on the computer or other programmable apparatus provide steps for implementing the functions/acts specified in the block diagrams and/or flowchart block or blocks.

Accordingly, example embodiments may be implemented in hardware and/or in software (including firmware, resident software, micro-code, etc.). Furthermore, example embodiments may take the form of a computer program product on a computer-usable or computer-readable storage medium having computer-usable or computer-readable program code embodied in the medium for use by or in connection with an instruction execution system. In the context of this document, a computer-usable or computer-readable medium may be any medium that can contain, store, communicate, propagate, or transport the program for use by or in connection with the instruction execution system, apparatus, or device.

The computer-usable or computer-readable medium may be, for example but not limited to, an electronic, magnetic, optical, electromagnetic, infrared, or semiconductor system, apparatus, device, or propagation medium. More specific examples (a non-exhaustive list) of the computer-readable medium would include the following: an electrical connection having one or more wires, a portable computer diskette, a random access memory (RAM), a read-only memory (ROM), an erasable programmable read-only memory (EPROM or Flash memory), an optical fiber, and a portable compact disc read-only memory (CD-ROM). Note that the computer-usable or computer-readable medium could even be paper or another suitable medium upon which the program is printed, as the program can be electronically captured, via, for instance, optical scanning of the paper or other medium, then compiled, interpreted, or otherwise processed in a suitable manner, if necessary, and then stored in a computer memory.

Computer program code for carrying out operations of data processing systems discussed herein may be written in a high-level programming language, such as Java, AJAX (Asynchronous JavaScript), C, and/or C++, for development convenience. In addition, computer program code for carrying out operations of example embodiments may also be written in other programming languages, such as, but not limited to, interpreted languages. Some modules or routines may be written in assembly language or even micro-code to enhance performance and/or memory usage. However, embodiments are not limited to a particular programming language. It will be further appreciated that the functionality of any or all of the program modules may also be implemented using discrete hardware components, one or more application specific integrated circuits (ASICs), or a programmed digital signal processor or microcontroller.

It should also be noted that in some alternate implementations, the functions/acts noted in the blocks may occur out of the order noted in the flowcharts. For example, two blocks shown in succession may in fact be executed substantially concurrently or the blocks may sometimes be executed in the reverse order, depending upon the functionality/acts involved. Moreover, the functionality of a given block of the flowcharts and/or block diagrams may be separated into multiple blocks and/or the functionality of two or more blocks of the flowcharts and/or block diagrams may be at least partially integrated.

For purposes of illustration and explanation only, various embodiments of the present invention are described herein in the context of a portable electronic device, specifically a mobile terminal. It will be understood, however, that the present invention is not limited to such embodiments and may be embodied generally in any device that is capable of performing operations in accordance with some embodiments of the present invention.

Modern conference rooms are typically equipped with electronic whiteboards that look just like regular whiteboards, but provide users the capability to print out the contents of the whiteboard. Some electronic whiteboards may be configured to be connected to a computer such that the contents of the whiteboard can be downloaded to the computer and printed, saved, changed, faxed and/or emailed. The capability of printing the contents of the whiteboard may allow for dynamic team collaboration where the whole team can participate in, for example, a brainstorming session or meeting without being distracted by writing everything on the board down, typing it into the computer or the like. Whenever meeting participants want to capture the contents of the whiteboard, for example, when the whiteboard is full or the meeting is over, a simple button press may copy the contents of the board onto paper or download the contents of the whiteboard to a computer.

The information written on these whiteboards can often be highly confidential. As such, not removing all of the information from the whiteboard before the next meeting is held or during a break in the meeting could be problematic. For example, the information could be exposed to individuals who are not entitled to such information and these individuals could quickly print a copy of the contents of the whiteboard for personal use. Accordingly, some embodiments of the present invention provide for the use of near field communications (NFC) capable devices to enable and/or disable dispersion of information from the whiteboard so as to reduce the likelihood that the information on the whiteboard is printed or downloaded by someone who is not entitled to the information thereon.

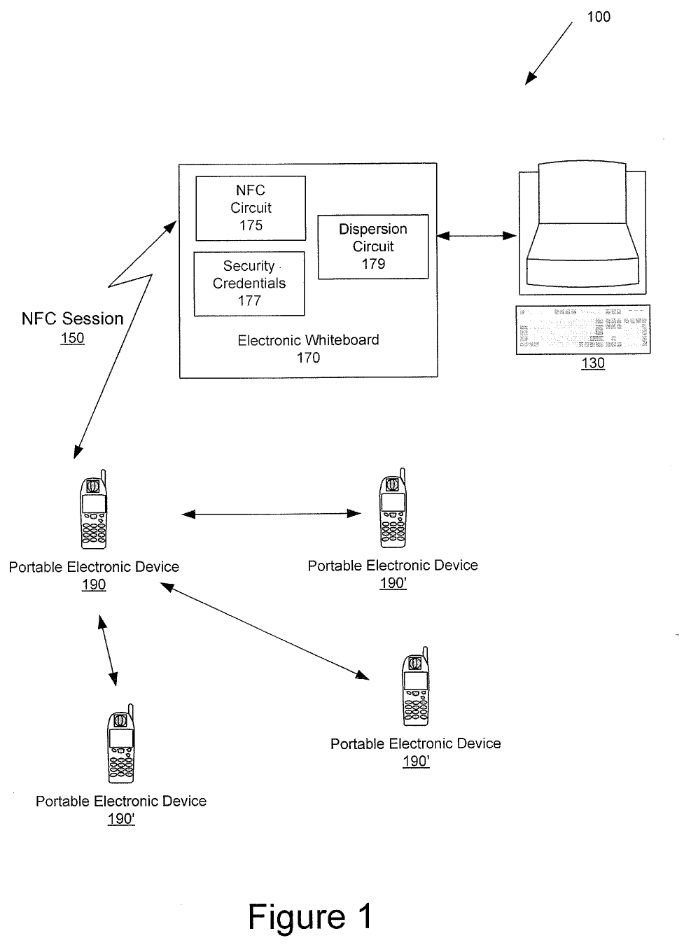

Accordingly, as will be discussed further below with respect to FIGS. 1 through 6, some embodiments of the present invention provide methods, portable electronic devices, systems and computer program products for securing an electronic whiteboard, such that the information cannot be printed and/or downloaded during meeting breaks or after the meeting is over by unauthorized persons. In particular, in some embodiments of the present invention a NFC session is established between a portable electronic device and the electronic whiteboard to secure information provided on the electronic whiteboard. Dispersion of the information provided on the electronic whiteboard may be enabled and/or disabled using security credentials associated with the established NFC session as will be discussed below with respect to FIGS. 1 through 6 below.

Referring first to FIG. 1, a system 100 in accordance with some embodiments of the present invention may include an electronic whiteboard 170 associated with a computer, and one or more portable electronic devices 190, 190′. It will be understood that although the computer 130 is illustrated as being separate from the electronic whiteboard 170 in FIG. 1, embodiments of the present invention are not limited to this configuration. For example, the electronic whiteboard 170 and the computer 130 can be combined without departing from the scope of the present invention. Furthermore, although embodiments of the present invention illustrated in FIG. 1 include a single computer 130 and electronic whiteboard 170 and four portable electronic devices 190, 190′, embodiments of the present invention are not limited to this configuration. Any number of these devices or additional devices may be included without departing from the scope of the present invention.

As illustrated in FIG. 1, the portable electronic device 190 in the system 100 is configured to establish an NFC Session 150 between the electronic whiteboard 170 and the portable electronic device 190. NFC is a standards-based (Ecma-340, ISO/IEC 18092), short-range wireless connectivity technology that may enable simple and safe two-way interactions among electronic devices, operating in the 13.56 MHz frequency range, over a typical distance of a few centimeters. NFC may use magnetic field induction to enable communication between devices when they're touched together, or brought within a few centimeters of each other. For example, NFC may be used to allow two or more portable electronic devices to exchange data. Instead of performing manual configurations, the connection between devices may be established automatically (<0.1 s). The underlying layers of NFC technology follow universally implemented ISO, ECMA and ETSI standards. Because the transmission range is so short, NFC-enabled transactions are inherently secure. Furthermore, proximity of the devices may give users the reassurance of being in control of the process. NFC can be used with a variety of devices, for example, mobile phones that enable payment or transfer information to digital cameras that send their photos to a TV set with just a touch. The specific functionality of NFC is known to those having skill in the art and, therefore, will not be discussed further herein in the interest of brevity.

As used herein, the term “portable electronic device” includes: a cellular radiotelephone with or without a multi-line display; a Personal Communications System (PCS) terminal that combines a cellular radiotelephone with data processing, facsimile and data communications capabilities; a Personal Data Assistant (PDA) that includes a radiotelephone, pager, Internet/intranet access, Web browser, organizer, calendar and/or a global positioning system (GPS) receiver; a gaming device, an audio video player, and a conventional laptop and/or palmtop portable computer that includes a radiotelephone transceiver. Any portable electronic device capable of operating in accordance with some embodiments of the present invention may be used without departing from the scope of the present invention.

In some embodiments to establish the NFC session 150, a unique key associated with an identifier that identifies a user of the portable electronic device 190 may be sent to the electronic whiteboard 170. As illustrated, the electronic whiteboard 170 may include an NFC circuit 175 and a dispersion circuit 179 and store security credentials 177 associated with various portable electronic devices. It will be understood that the security credentials may be stored at a centralized server without departing from the scope of the present invention. The electronic whiteboard 170 receives the unique key at the NFC circuit 175 and transmits a sharing code to the portable electronic device 190, which when provided allows access to the information on the electronic whiteboard 170. This sharing code may be provided to at least one other portable electronic device 190′ so as to allow access to the information provided on the whiteboard 170 to other portable electronic devices 190′. In some embodiments, the additional portable electronic devices 190′ may have limited access, and the originating portable electronic device 190 may have unrestricted access to the information on the electronic whiteboard 170. Dispersion of the information on the electronic whiteboard 170, for example, printing or downloading, may be enabled and/or disabled using security credentials associated with the established NFC session, for example, the sharing code. In other words, a portable electronic device 190, 190′ may provide the sharing code to the electronic whiteboard 170 and, upon verification, the information provided on the electronic whiteboard 170 may be dispersed. In some embodiments of the present invention, the information on the electronic whiteboard 170 may be further secured by securing the portable electronic device 190, 190′ using a biometric link, for example, a thumb print. Thus, the portable electronic device 190, 190′ may require verification of a biometric link to access the security credentials associated with the NFC session. Thus, according to some embodiments of the present invention, the use of NFC enabled portable electronic devices 190, 190′ to provide secure credentials may reduce the likelihood of unauthorized printing and/or downloading of the information on the electronic whiteboard 170 when the electronic whiteboard 170 has been left unattended.

Operations according to some embodiments of the present invention will be discussed with respect to the system 100 of FIG. 1. As discussed above, the portable electronic devices 190, 190′ and the electronic whiteboard 170 are both equipped with NFC capable hardware. To begin an NFC session 150, the user of the portable electronic device 190, for example, the meeting organizer, may secure the electronic whiteboard 170 with a unique key associated with portable electronic device 190. The electronic whiteboard 170 is configured to return a key to the portable electronic device 190 as a sharing code. The user of the portable electronic device 190 may send the sharing code to any number of other portable electronic devices 190′, for example, portable electronic devices associated with other meeting participants or team members. Once a user is logged on and secured, the electronic whiteboard 190 will disable all printing, downloading, storing and the like from the electronic whiteboard 170. In some embodiments of the present invention, the electronic whiteboard 170 may also be configured to automatically erase all previous material when a new NFC session 150 is established.

During the NFC session 150, each time dispersion of the information on the whiteboard 170 is requested, the user of a portable electronic device 190, 190′ provides the security credentials, for example, the sharing code, to enable dispersion. In some embodiments of the present invention, the originating portable electronic device 190 may have full capabilities and the portable electronic devices 190′ receiving the sharing code may have a subset of capabilities. For example, the use of a sharing code may require the whiteboard 170 to “watermark” all designs when printing information from the whiteboard 170, but printing originated by the portable electronic device 190 may allow unencumbered access. In embodiments of the present invention where the board content is electronically stored, the access rights of the stored document may be automatically inherited from the NFC equipped device 190, 190′.

As discussed above, for additional security, the portable electronic device 190 may implement a biometric link to the secure element in the phone. It will be understood that in some embodiments of the present invention, the portable electronic device 190, 190′ is key to implementation of aspects of the present invention because the portable electronic device 190, 190′ may implement the mobile processing power to determine rights and permissions and the electronic whiteboard 170 may just pass through some security rights and implement enabling and/or disabling dispersion of the information on the electronic whiteboard 170.

Providing secure access to dispersion of the information on the electronic whiteboard 170 may provide the ability to log usage of the whiteboard 170, to connect the content on the whiteboard with the originating portable electronic device 190 or at least the securer of the whiteboard 170. Furthermore, some embodiments of the present invention may provide an element of security to conference room whiteboards at minimal cost when coupled with other potential end to end systems that can be enabled by the secure element in the portable electronic device, which may further enhance the value of NFC enabled devices.

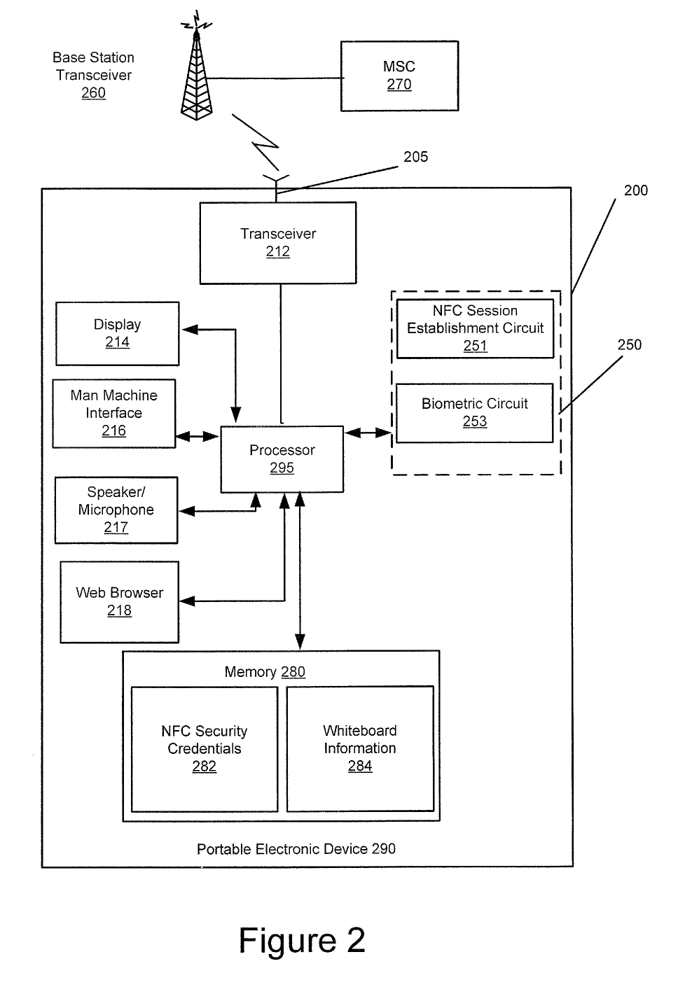

Referring now to FIG. 2, details with respect to NFC enabled portable electronic devices 290 in accordance with some embodiments of the present invention will be discussed. As illustrated in FIG. 2, the portable electronic device 290 includes a portable housing 200 and may include a display 214, a man machine interface (MMI) 216, a speaker/microphone 217, a web browser 218, a transceiver 212 and a memory 280, any of which may communicate with a processor 295. Furthermore, portable electronic devices 290 according to embodiments of the present invention may further include a securing circuit 250 according to some embodiments of the present invention, which also communicates with the processor 295. The processor 295 can be any commercially available or custom microprocessor.

As further illustrated in FIG. 2, the portable electronic device 290 communicates with a base station transceiver 260 connected to a mobile switching center (“MSC”) 270 in accordance with some embodiments of the present invention. The transceiver 212 typically includes a transmitter circuit and a receiver circuit, which respectively transmit outgoing radio frequency signals to the base station transceiver 260 and receive incoming radio frequency signals, such as voice and data signals, from the base station transceiver 260 via an antenna 205. The antenna 205 may be an embedded antenna, a retractable antenna or any antenna known to those having skill in the art without departing from the scope of the present invention. The radio frequency signals transmitted between the portable electronic device 290 and the base station transceiver 260 may include both traffic and control signals (e.g., paging signals/messages for incoming calls), which are used to establish and maintain communication with another party or destination. The processor 295 may support various functions of the portable electronic device, including a securing circuit 250 configured to establish an NFC session with an electronic whiteboard as discussed above according to some embodiments of the present invention as will be discussed further herein.

It will be understood that in some embodiments of the present invention, the transceiver 212 may be a short range transceiver. The short range transceiver may be, for example, a Bluetooth transceiver, which may allow for high transfer rates of data over relatively short distances. It will be further understood that portable electronic devices 290 according to some embodiments of the present invention may include a wireless transceiver and a short range transceiver/transmitter.

In some embodiments of the present invention, the base station transceiver 260 includes the radio transceiver(s) that defines an individual cell in a cellular network and communicates with the portable electronic device 290 and other portable electronic devices in the cell using a radio-link protocol. Although only a single base station transceiver 260 is shown, it will be understood that many base station transceivers may be connected through, for example, a mobile switching center 270 and other devices to define a wireless communications network.

Although the present invention may be embodied in communication devices or systems, such as the portable electronic device 290, the present invention is not limited to such devices and/or systems. Instead, the present invention may be embodied in any apparatus that may be configured to operate in accordance with some embodiments of the present invention.

As illustrated in FIG. 2, the memory 280 includes NFC security credentials 282 and whiteboard information 284. Although only two files are shown in the memory 280 of FIG. 2, any number of files may be stored without departing from the scope of the present invention. As further illustrated in FIG. 2, the securing circuit 250 includes an NFC session establishment circuit 251 and a biometric circuit 253. Although two circuits are illustrated in FIG. 2, it will be understood that these circuits/modules can be split into three or more circuits/modules or combined into a single circuit/module without departing from the scope of the present invention.

Some embodiments of the present invention will now be discussed with respect to FIGS. 1 and 2. In particular, the near field communication (NFC) session establishment circuit 251 is configured to establish an NFC session 150 between the portable electronic device 290 and the electronic whiteboard 170 to secure information provided on the electronic whiteboard 170. The dispersion circuit 170 may be configured to enable and/or disable dispersion of the information provided on the electronic whiteboard using security credentials associated with the established NFC session 150. The dispersion circuit 170 may be configured to store the information provided on the electronic whiteboard or print the information provided on the electronic whiteboard without departing from the scope of the present invention. The electronic whiteboard information 284 may be stored at the portable electronic device 290, at the whiteboard 170 or both without departing from the scope of the present invention.

In some embodiments of the present invention, the security credentials may include a unique key associated with an identifier that identifies a user of the portable electronic device 190, 290. The NFC session establishing circuit 251 may be further configured to transmit the unique key to the electronic whiteboard 170 and receive a unique sharing code from the electronic whiteboard 170 responsive to the provision of the unique key.

The NFC session establishing circuit 251 may be further configured to transmit the sharing code received from the electronic whiteboard 170 to at least one other portable electronic device 190′ so as to allow others access to the information provided on the electronic whiteboard. As discussed above, the portable electronic devices having access to the information using the sharing code may only have limited access to the information on the electronic whiteboard 170.

As further illustrated in FIG. 2, the securing circuit 250 further includes a biometric circuit 253. The biometric circuit may be configured to require verification of biometric link to access the security credentials associated with the NFC session. For example, the portable electronic device 190 may be configured to verify a thumb print of the user before allowing the user access to the portable electronic device 190, 290 and the security credentials 282 stored therein.

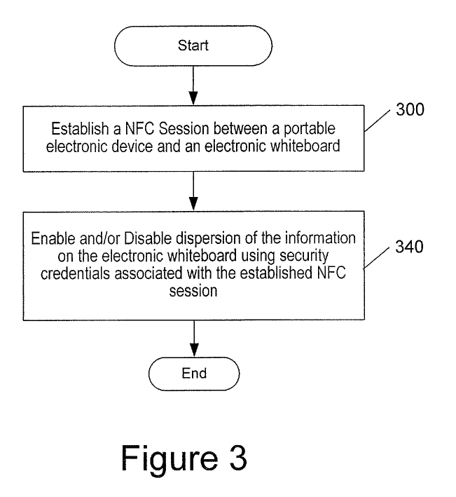

Referring now to FIGS. 3 through 6, operations according to various embodiments of the present invention will be discussed. Blocks denoted by dotted lines represent optional operations. Referring first to FIG. 3, operations for securing an electronic whiteboard begin at block 300 by establishing a NFC session between a portable electronic device and the electronic whiteboard to secure information provided on the electronic whiteboard. The dispersion, for example, printing or downloading, of the information provided on the electronic whiteboard is disabled and/or enabled using security credentials associated with the established NFC session (block 340). In some embodiments of the present invention, the security credentials may include a unique key associated with an identifier that identifies a user of the portable electronic device.

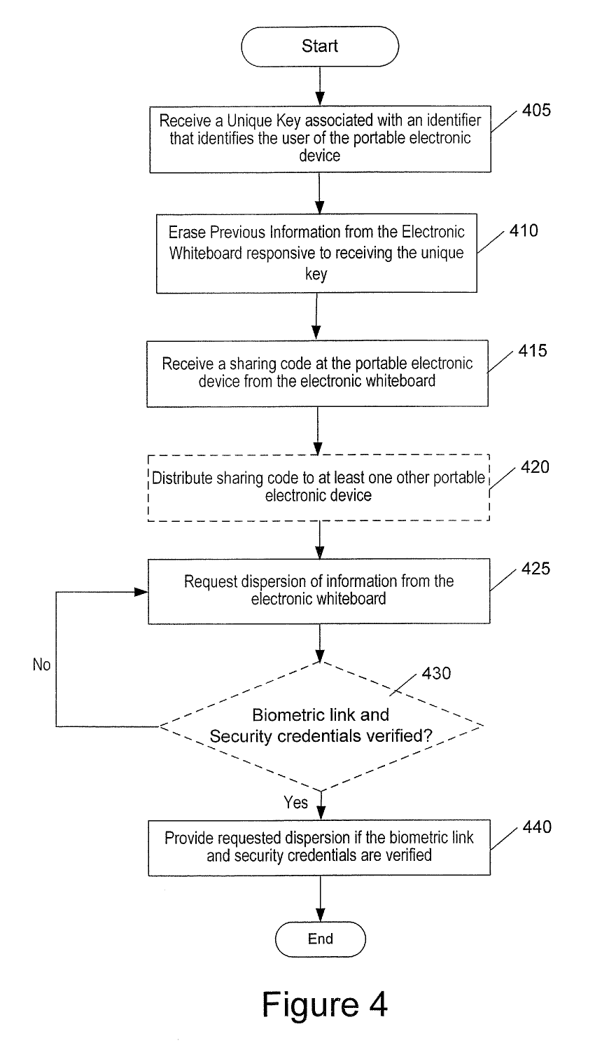

Referring now to FIG. 4, operations begin at block 405 by transmitting the unique key to the electronic whiteboard (block 405). In some embodiments, once the unique key is received at the whiteboard, the information from any previous sessions may be automatically erased (block 410). A unique sharing code may be received from the electronic whiteboard at the portable electronic device responsive to the transmission of the unique key (block 415). In some embodiments of the present invention, the originating portable electronic device may transmit the sharing code received from the whiteboard to at least one other portable electronic device so as to allow others access to the information provided on the electronic whiteboard (block 420). As discussed above, limited access to the information provided on the electronic whiteboard may be provided to the portable electronic device receiving the sharing code.

Dispersion of information on the electronic whiteboard may be requested (block 425). It may be determined if a biometric link and/or security credentials have been verified (block 430). If verified, the requested dispersion may be provided (block 440). For example, the information provided on the electronic whiteboard may be stored or printed. In some embodiments of the present invention, the information provided on the electronic whiteboard may be stored at the electronic whiteboard and/or at the portable electronic device using the established NFC session. If, on the other hand, the security credentials are not verified (block 430), operations return to block 425 and repeat when another request for dispersion is received.

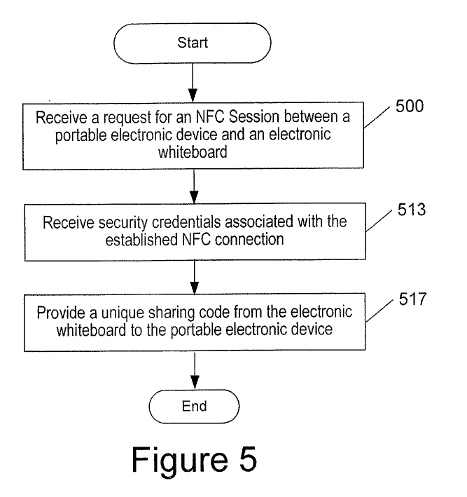

Referring now to FIG. 5, operations begin at block 500 by receiving a request for a near field communication (NFC) session between a portable electronic device and the electronic whiteboard to secure information provided on the electronic whiteboard. Security credentials associated with the established NFC connection are received (block 513). The security credentials may include a unique key associated with an identifier that identifies a user of the portable electronic device. A unique sharing code may be provided from the electronic whiteboard to the portable electronic device responsive to the provision of the unique key (block 517).

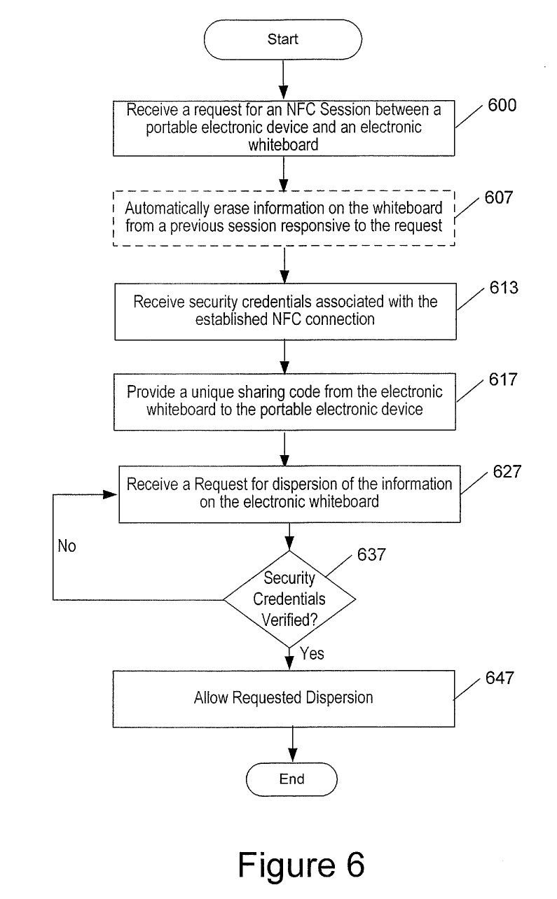

Referring now to FIG. 6, operations begin at block 600 by receiving a request for a NFC session between a portable electronic device and the electronic whiteboard to secure information provided on the electronic whiteboard. The information from any previous sessions may be erased from the electronic whiteboard (block 607). Security credentials associated with the established NFC connection are received (block 613). The security credentials may include a unique key associated with an identifier that identifies a user of the portable electronic device. A unique sharing code may be provided from the electronic whiteboard to the portable electronic device responsive to the provision of the unique key (block 617). A request for dispersion of the information on the electronic whiteboard may be received (block 627). It is determined if the security credentials are verified (block 637). If verified, the requested dispersion is allowed (block 647). If, on the other hand, the security credentials are not verified (block 637), operations return to block 627 and repeat when another request for dispersion is received.

In the drawings and specification, there have been disclosed exemplary embodiments of the invention. However, many variations and modifications can be made to these embodiments without substantially departing from the principles of the present invention. Accordingly, although specific terms are used, they are used in a generic and descriptive sense only and not for purposes of limitation, the scope of the invention being defined by the following claims.

That which is claimed:

1. A method for securing an electronic whiteboard comprising:
establishing a near field communication (NFC) session between a portable electronic device and the electronic whiteboard to secure information provided on the electronic whiteboard; and
enabling and/or disabling dispersion of the information provided on the electronic whiteboard using security credentials associated with the established NFC session.

2. The method of claim 1:
wherein the security credentials comprise a unique key associated with an identifier that identifies a user of the portable electronic device; and
wherein establishing the NFC session comprises transmitting the unique key to the electronic whiteboard and receiving a unique sharing code from the electronic whiteboard responsive to the transmission of the unique key.

3. The method of claim 2, further comprising transmitting the sharing code received from the electronic whiteboard to at least one other portable electronic device so as to allow others access to the information provided on the electronic whiteboard.

4. The method of claim 3, providing limited access to the information provided on the electronic whiteboard to the at least one other portable electronic device receiving the sharing code.

5. The method of claim 1, wherein establishing the NFC session is followed by automatically erasing information on the electronic whiteboard from a previous session.

6. The method of claim 1, wherein enabling and/or disabling dispersion comprises storing the information provided on the electronic whiteboard or printing the information provided on the electronic whiteboard.

7. The method of claim 6, wherein storing comprises automatically storing the information provided on the electronic whiteboard at the electronic whiteboard and at the portable electronic device using the established NFC session.

8. The method of claim 1, further comprising requiring verification of a biometric link to access the security credentials associated with the NFC session.

9. The method of claim 1 implemented by a portable electronic device.

10. The method of claim 1 implemented by a computer program product comprising a computer-readable storage medium having computer-readable program code embodied in said medium.

11. A method for securing an electronic whiteboard comprising:
receiving a request for a near field communication (NFC) session between a portable electronic device and the electronic whiteboard to secure information provided on the electronic whiteboard;
receiving security credentials associated with the established NFC connection, the security credentials including a unique key associated with an identifier that identifies a user of the portable electronic device; and
providing a unique sharing code from the electronic whiteboard to the portable electronic device responsive to the provision of the unique key.

12. The method of claim 11, comprising:
receiving a request for dispersion of the information provided on the electronic whiteboard, the request including the security credentials associated with the established NFC session;
verifying the security credentials; and
allowing the requested dispersion if the security credentials are verified.

13. The method of claim 12, wherein receiving the request for the NFC session is followed by automatically erasing information on the electronic whiteboard from a previous session.

14. The method of claim 11 implemented by a portable electronic device.

15. The method of claim 11 implemented by a computer program product comprising a computer-readable storage medium having computer-readable program code embodied in said medium.

16. A system for securing an electronic whiteboard, the system comprising:
an near field communication (NFC) session establishing circuit configured to establish an NFC session between a portable electronic device and the electronic whiteboard to secure information provided on the electronic whiteboard; and
a dispersion circuit configured to enable and/or disable dispersion of the information provided on the electronic whiteboard using a security credentials associated with the established NFC session.

17. The system of claim 16:
wherein the security credentials comprise a unique key associated with an identifier that identifies a user of the portable electronic device; and
wherein the NFC session establishing circuit is further configured to transmit the unique key to the electronic whiteboard and receive a unique sharing code from the electronic whiteboard responsive to the provision of the unique key.

18. The system of claim 17, wherein the portable electronic device is configured to transmit the sharing code received from the electronic whiteboard to at least one other portable electronic device so as to allow others access to the information provided on the electronic whiteboard.

19. The system of claim 16, wherein the dispersion circuit is further configured to store the information provided on the electronic whiteboard or print the information provided on the electronic whiteboard.

20. The system of claim 16, further comprising a biometric circuit configured to require verification of biometric link to access the security credentials associated with the NFC session.
